(19) United States
(12) Patent Application Publication
(10) Pub. No.: US 2005/0019457 A1
(43) Pub. Date: Jan. 27, 2005

(54) Aromatic herb preparation

(76) Inventor: Baudouin Van Aefferden, Dissen (DE)

Correspondence Address: JOHN S. PRATT, ESQ;KILPATRICK STOCKTON, LLP, 1100 PEACHTREE STREET, ATLANTA, GA, 30309, US

(21) Appl. No.: 10/496,914

(22) PCT Filed: Dec. 3, 2002
(86) PCT No.: PCT/DE02/04669

(30) Foreign Application Priority Data
Dec. 7, 2001 (DE) 101 60 309.6

(51) Int. Cl. A23B 4/00

(52) U.S. Cl. 426/310

(57) ABSTRACT

A preserved preparation of at least one pot-herb, containing at least one composition adjusting the water activity of the preparation to 0.90 or less and containing at least one substance raising the pH of the preparation by at least 1.0 points compared to the pH of the pot-herb(s) after addition of the composition adjusting the water activity, wherein the preparation additionally contains at least one anti-oxidant and/or is packed so as to be protected against oxygen.

The invention relates to a preserved preparation of at least one pot-herb and a method of producing such a preparation.

Pot-herbs are used fresh, deep-frozen or dried. The highest organoleptic quality is certainly found in a fresh herb. One disadvantage is that one cannot tell just by looking at a chopped herb whether it really is still fresh. By deep-freezing, the fresh condition can be extended, thus creating a storage possibility. A disadvantage of deep-freezing is the amount of apparatus required and the impairment in the taste and appearance of the deep-frozen products compared to fresh products.

Dried herbs also permit a long storage time. For this purpose, however, it is necessary to reduce the moisture content to 12% or less. During dewatering (dehydration), the herbs unfortunately suffer a loss of aroma as a consequence of the evaporation of the water during the drying process, especially in the last phase of drying, and/or as a result of the oxidation of sensitive flavourings during storage. Drying the aromatic plants or parts thereof frequently entails a discoloration, often a brown colouring.

Other preservation measures for herbs are known, such as pasteurisation or sterilisation, which are intended, inter alia, to preserve the taste of the fresh herbs. Nevertheless, the taste and appearance of the herbs are also impaired by these measures.

It is also known to preserve herbs in an acid medium, though this is usually accompanied by a more rapid change in colour.

U.S. Pat. No. 5,368,873 describes a dried vegetable which, before drying, has been treated with a liquid containing an osmotic agent. The osmotic agent must infuse into the vegetable tissue and be capable of forming an amorphous solid upon drying. Agents mentioned which have an osmotic effect are syrups and sugars.

EP 0 087 717 A1 proposes a free-flowing dry spice plant product containing alkali and/or earth alkali salts of inorganic and/or organic acids, proteins and/or hydrogenated carbohydrates as carriers, which, after compounding with the carriers, is dried, optionally at an elevated temperature.

U.S. Pat. No. 4,572,836 describes a herb composition with a pH of <4.5 containing about 7.5% NaCl, anti-oxidants and 25 to 70% by weight edible oil. The fresh herbs are admixed with the water activity controlling substances and processed into an acidified paste. Practice shows, however, that green herbs lose their attractive colour as a result of these measures, which happens all the more rapidly, the more acidic the medium is. It can be stated that these changes of colour can almost always be regarded as a visible criterion for a sensory deviation.

U.S. Pat. No. 5,858,446 describes a pot-herb preparation in which a comminuted fresh pot-herb is admixed with a substance to adjust the water activity to 0.90 or less and an anti-oxidant, the pot-herb preparation being stored in a substantially oxygen-free atmosphere.

The invention is based on the problem of providing a method of preserving pot-herbs which can be applied to fresh herbs or partially hydrated herbs with a moisture content of at least 30% by weight, the intention being for the pot-herb preparation to retain, to a great extent, the taste of the fresh herbs and to remain stable over a long period against decomposition by micro-organisms, against their own enzymes and against oxidation. In this context, the intention is in particular to dispense with pasteurisation and frozen storage, since these measures might increase the price of the product and have a negative influence on the purchasing behaviour of the consumer.

In accordance with the invention, this problem is solved by a preserved preparation of at least one pot-herb, containing at least one composition adjusting the water activity of the preparation to 0.90 or less and containing at least one substance raising the pH of the preparation by at least 1.0 points, compared to the pH of the pot-herb(s) after the addition of the composition to adjust the water activity, the preparation additionally containing at least one anti-oxidant and/or being packed so as to be protected against oxygen.

It is advantageous for the pH of the preparation to be raised by 1.5 to 2.5, most preferably by about 2, points.

The adjustment of the water activity is preferably achieved by a proportion of table salt of at least about 10% by weight, preferably 20% by weight or more, based on the mass of the preparation.

In a preferred embodiment of the invention, the pH is adjusted by adding at least one substance, which is preferably selected from the group of alkali and earth alkali metal salts of inorganic or organic acids, especially selected from among sodium carbonate, sodium bicarbonate, magnesium carbonate and calcium carbonate.

In a preferred embodiment, the preparation is characterised by an additional content of at least one earth alkali metal salt, especially a calcium and/or magnesium salt.

In addition, the invention relates to a method of producing a preserved preparation of at least one pot-herb, which is characterised in that the pot-herb(s) is (are) prepared with a moisture content of at least 30% by weight; and that the pot-herb(s) is (are) mixed, after or during comminution, with a preservation mixture containing at least one composition adjusting the water activity in an amount sufficient to adjust the water activity in the preparation to 0.90 or less, and at least one substance to raise the pH in an amount sufficient to raise the pH by at least 1.0 points compared to the pH of the pot-herb(s) after the addition of the water activity adjusting composition, at least one anti-oxidant being added to the preservation mixture or the mixture of pot-herb(s) and preservation mixture and/or the preparation being packed so as to be protected against oxygen.

In the process, in order to adjust the water activity of the preparation, table salt is preferably added to the preservation mixture in an amount sufficient to adjust the proportion of table salt in the preparation such that, based on the mass of the preparation, it amounts to at least about 10% by weight.

In addition, the method is characterised by a preservation mixture to which is added, in order to raise the pH, at least one substance from the group of alkali and earth alkali metal salts of inorganic or organic acids, preferably selected from among sodium carbonate, sodium bicarbonate, magnesium carbonate and/or calcium carbonate.

It is preferable for at least one earth alkali metal salt, particularly preferably a calcium and/or magnesium salt, to be added to the preservation mixture or the mixture of pot-herb(s) and preservation mixture in addition.

In a preferred embodiment of the method of the invention, the proportion of the preservation mixture, based on the mass of the preparation, is between about 25 and 35% by weight.

It has been surprisingly found that by the combination of the following three features: 1. raising the pH by at least 1.0 points, compared to the pH of the corresponding pot-herb or the corresponding mixture of pot-herbs after the addition of the water activity adjusting composition, as a result of which the pH is distinctly higher than the standard pHs used for preserving pot-herbs, which are no more than about 4, and will usually also be distinctly higher than the physiological pH of the pot-herb, preferably as a consequence of adding such substances as sodium carbonate, sodium bicarbonate, magnesium carbonate, calcium carbonate, etc. in an appropriate amount; 2. adjusting the water activity of the preparation to 0.90 or less, preferably by the addition of table salt in an appropriate amount; and 3. adding anti-oxidant and/or storing while protected against oxygen, it is possible to obtain a herb preparation which retains the fresh taste and the fresh appearance of the pot-herbs over a lengthy period. In particular, it could not be foreseen that, with the high pH of the invention in combination with the low water activity, the reduction in germs attained could be achieved and at the same time the oxidation usually associated with raising the pH could be almost completely suppressed so easily.

The preparation of the invention retains the fresh green nature of the freshly harvested herb over a period of at least 3 months, though when stored in a refrigerator, i.e. at 3 to 5° C., a product can be observed which is still excellent even after 18 months.

An important aspect of the preservation in accordance with the present invention is the increase in pH by at least 1.0 points, compared to the pHs of the corresponding pot-herb or the corresponding mixture of pot-herbs after the addition of the water activity adjusting composition. The absolute pH of the final preserved preparation can fluctuate here, depending on the physiological pH of the pot-herb used or the mixture of pot-herbs used. Preserved preparations of pot-herbs with an originally relatively low pH, such as oregano, have a pH of about 6.5 to 7 in the preserved preparation, while other pot-herbs which already have a higher pH in their original condition, such as parsley, have a pH of 8 to 9 in the final preserved preparation. In order to achieve the desired effect in accordance with the invention, it is apparent that a pH leap on the appropriate scale must take place, even though it is at present not yet possible to explain the reason why.

In order to adjust the pH, buffer mixtures can be used which are conventional in the food industry, especially the above-mentioned alkali and earth alkali metal salts of carbonic acid. Other suitable candidates are alkali and earth alkali metal salts of other inorganic or organic acids, such as phosphoric acid, citric acid, lactic acid and amino acids. Apart from those, however, basic compounds, such as sodium hydroxide, potassium hydroxide or the like, are also suitable.

In order to adjust a suitable pH, amounts of 0.1 to 5% by weight, based on the mass of the preparation, are usually sufficient. As shown in the examples below, the amount of, for example, sodium carbonate needed to raise the pH by 1.5 and 2.5 points is 0.25 to 1.0% by weight. A second important aspect of the preparation of the invention, or of the preservation method of the invention, is the adjustment of the water activity to 0.90 or less, preferably to less than 0.80, though this measure alone, as already observed above, is already known from the state of the art, e.g. from U.S. Pat. No. 5,858,446. The positive effect is based on the fact that, when the water activity is low, the growth of micro-organisms is inhibited. However, the surprising synergistic effect of the combination with the pH rise described is not known from the prior art.

As already described in more detail in the above-mentioned U.S. Pat. No. 5,858,446, especially a salt authorised for use in foodstuffs, such as sodium chloride, potassium chloride, calcium chloride, sodium citrate or sodium lactate, can be used to adjust the water activity. According to the present invention, sodium chloride, i.e. table salt, is preferably used, which is added in an amount such that the proportion of table salt in the preparation is at least 10% by weight, preferably 20% by weight or more. In the examples described below, the content of table salt is 25% by weight, which results in an a_{w} value of 0.71-0.75. In order to accelerate dissolution of the salt, the table salt is preferably used in a micronised form (i.e. a “microsalt”).

It has been found that the addition of the substance adjusting the water activity to the required level, which is usually an electrolyte, such as table salt, lowers the pH of the pot-herb distinctly, i.e. into the acid range, as also becomes clear from the tables in the following examples. In accordance with the invention, the pH of the preparation, compared to this pH, is then raised by at least 1.0 points by the addition of corresponding substances, such as sodium carbonate, which will also usually raise it well over the physiological pH of the pot-herb again.

As a third component of the preservation method of the invention, it is necessary to add a so-called anti-oxidant, i.e. a substance known in food technology to inhibit oxidation. Sodium ascorbate, for example, is particularly suitable in this respect. The use of such substances in preserved pot-herb compositions is of course already known from the state of the art, such as U.S. Pat. No. 5,858,446, which has already been quoted. It was nevertheless surprising that the addition of this conventional anti-oxidant in conventional amounts was suitable for counteracting the powerful oxidation resulting from the increase in pH as effectively as was observed.

The content of anti-oxidant in the preparation is 2 to 5% by weight, preferably about 4% by weight of sodium ascorbate, for example.

As an alternative to the use of an anti-oxidant, it can be provided to store the product protected against oxygen. This can, for example, be vacuum packing, application of an inert gas, such as nitrogen, or storage under liquids providing protection against oxygen, such as edible oil.

In the preservation method of the invention, the pot-herb or the pot-herb mixture is prepared either in the form of fresh herbs or partially hydrated with a moisture content of at least 30% by weight. If the degree of dehydration is greater, the appearance and sensory characteristics are already severely impaired. The preservation method of the invention is particularly suitable for preserving fresh herbs.

Pot-herbs for the purposes of the present invention are understood to mean plants or parts of plants which are used to modify and/or refine the taste in the preparation of food. Pot-herbs of this kind are, for example, basil, thyme, sage, celeriac, coriander, dill, oregano, marjoram, rosemary, parsley, chillies, mint, peppermint, garlic and chives. These can of course also be used in any mixtures desired.

According to the method of the invention, the fresh or partially hydrated pot-herb is comminuted and, after or during comminution, a preservation mixture is added which contains the substance adjusting the water activity and the compound to raise the pH in appropriate relative proportions. It is also preferable already to add the anti-oxidant to the preservation mixture, though it can also be added immediately after the pot-herb and preservation mixture are mixed. In order to optimise the preservation method, it is advantageous to carry out the entire method, or at least major part-steps thereof, with oxygen excluded.

The proportion of preservation mixture in the preserved preparation of the invention is 20 to 50% by weight, preferably 25 to 35% by weight and most preferably about 30% by weight, based on the mass of the preparation of the invention in each case.

It has surprisingly also been found that the further addition of a magnesium or calcium salt preserves the fresh green character of the preserved pot-herb even better than can already be achieved in accordance with the invention. In a preferred embodiment of the invention, it is therefore provided also to add a magnesium or calcium salt to the preserved preparation in addition, such as calcium carbonate or magnesium chloride hexahydrate, in amounts from 0.5 to 1% by weight.

The advantages of the preservation method of the invention, or the advantageous characteristics of the preserved pot-herb preparation of the invention can be demonstrated with reference to the enclosed Tables I to IV, in which the colour and aroma of four different pot-herb preparations were evaluated over a period of four weeks and scored according to a scale of 1 to 6.

In the case of aroma, the score 1 corresponds very well to that of a fresh herb. The aroma diminishes as the score goes up, until, at score 5, its flacour is hardly typical of the fresh herb any longer and it has a distinctly different, spoiled taste. In the case of colour, score 1 corresponds to the colour of freshly processed herb or can even be more intensive. As the score goes up, an ever more pronounced discoloration and thus deviation from the fresh colour occurs. At score 5, the deviation in colour is so pronounced that it would no longer be associated with a fresh pot-herb.

As a rule, the aroma declines in intensity and in profile. The evaluation primarily considers the typology, or the aroma profile, but also the intensity, which are characteristic of the herb concerned. In addition, any deviations in taste that might occur are also taken into account. The same also applies to the colour. Apart from the disappearance of the original grass-green, other shades appear in the course of time, such as grey, brown and olive green. Here too, the intermediate stages are marked with the corresponding score.

Comparative example 1 (V1) relates to the fresh herb without any preservation measures. Comparative example 2 (V2) shows the scores for the fresh herb with the addition of 25% by weight NaCl. Comparative example 3 (V3) shows the scores for the fresh herb with the addition of 25% by weight NaCl and 4% by weight sodium ascorbate. Comparative example 4 (V4) corresponds to comparative example 2 with the exception that the product was stored with oxygen excluded, namely in a vacuum. Comparative example 5 (V5) corresponds to comparative example 3, likewise stored under a vacuum.

Example 1 shows the scores for fresh herb with 25% by weight NaCl, 4% by weight sodium ascorbate and sodium carbonate. Example 2 corresponds to Example 1 in terms of the components, though with a higher proportion of sodium carbonate. Example 3 shows the scores for a vacuum-packed fresh herb with 25% by weight NaCl and sodium carbonate, Example 4 a fresh herb with 25% by weight NaCl, 4% by weight sodium ascorbate and sodium carbonate, likewise vacuum-packed. Examples 5 to 7 correspond to the addition of 25% by weight NaCl, 4% by weight sodium ascorbate and sodium carbonate and calcium carbonate and/or magnesium chloride hexahydrate.

TABLE I

| | V1 | V2 | V3 | V4 | V5 | 1 | 2 | 3 |
|---|---|---|---|---|---|---|---|---|
| | Normal | | | | | Normal | Normal | Vacuum |
| | nothing | Normal | Normal | Vacuum | Vacuum | NaCl + NaAsc + Na₂CO₃ | NaCl + NaAsc + Na₂CO₃ | NaCl + Na₂CO₃ |
| Parsley | added | NaCl | NaCl + NaAsc | NaCl | NaCl + NaAsc | (0.25%) | (0.6%) | (0.6%) |
| pH | 6.15 | 5.46 | 5.37 | 5.10 | 5.22 | 7.34 | 7.91 | 8.49 |
| 1 week | 5 | 2 | 2 | 2 | 3 | 2 | 2 | 1-2 |
| Colour | 5 | 2 | 2 | 1-2 | 1-2 | 2 | 2 | 1 |
| 4 weeks | 5 | 3-4 | 3-4 | 3 | 3-4 | 2-3 | 2 | 2 |
| Colour | 5 | 3-4 | 3-4 | 3 | 3-4 | 3 | 3 | 2 |

| | 4 | 5 | 6 | 7 |
|---|---|---|---|---|
| | | | Normal | Normal |
| | Vacuum | Normal | NaCl + NaAsc + Na₂CO₃ | NaCl + NaAsc + Na₂CO₃ |
| | NaCl + NaAsc + Na₂CO₃ | NaCl + NaAsc + Na₂CO₃ | (0.6%) + MgCl₂.6H₂O | (0.6%) + CaCO₃ |
| Parsley | (0.6%) | (0.6%) | (0.5%) | (0.6%) + MgCl₂.6H₂O |
| pH | 7.40 | 6.83 | 6.61 | 6.72 |
| 1 week | 1 | 1 | 1 | 1 |
| Colour | 1 | 2 | 2 | 2 |
| 4 weeks | 2-3 | 1-2 | 2 | 2 |
| Colour | 2-3 | 2 | 2 | 3 |

TABLE II

| | V1 | V2 | V3 | V4 | V5 | 1 | 2 | 3 |
|---|---|---|---|---|---|---|---|---|
| | Normal | | | | | | | Vacuum |
| | nothing | Normal | Normal | Vacuum | Vacuum | Normal | Normal | NaCl + Na₂CO₃ |
| Basil | added | NaCl | NaCl + NaAsc | NaCl | NaCl + NaAsc | NaCl + NaAsc + Na₂CO₃ | NaCl + NaAsc + Na₂CO₃ | (0.6%) |
| pH | 6.15 | 5.46 | 5.75 | 5.29 | 5.36 | 7.55 | 8.2 | 8.12 |
| 1 week | 5 | 2-3 | 3 | 2 | 3 | 1-2 | 1-2 | 1-2 |
| Colour | 5 | 3 | 3 | 2 | 2 | 2-3 | 2 | 1 |
| 4 weeks | 5 | 4-5 | 4 | 3 | 3 | 3 | 2 | 1-2 |
| Colour | 5 | 3 | 3 | 3 | 3 | 2-3 | 2 | 2 |
| Aroma | | | | | | | | |

| | 4 | 5 | 6 | 7 |
|---|---|---|---|---|
| | Vacuum | Normal | Normal | Normal |
| Basil | NaCl + NaAsc + Na₂CO₃ | NaCl + NaAsc + Na₂CO₃ | NaCl + NaAsc + Na₂CO₃ | NaCl + NaAsc + Na₂CO₃ |
| pH | 7.42 | 7.51 | 7.44 | 7.47 |
| 1 week | 1 | 1 | 1 | 1 |
| Colour | 1 | 1-2 | 1-2 | 1-2 |
| 4 weeks | 2 | 1-2 | 2 | 2 |
| Colour | 1-2 | 1-2 | 2 | 1-2 |
| Aroma | | | | |

TABLE III

| | V1 | V2 | V3 | V4 | V5 | 1 | 2 | 3 |
|---|---|---|---|---|---|---|---|---|
| | Normal | | | | | Normal | Normal | Vacuum |
| | nothing | Normal | Normal | Vacuum | Vacuum | NaCl + NaAsc + Na₂CO₃ | NaCl + NaAsc + Na₂CO₃ | NaCl + Na₂CO₃ |
| Oregano | added | NaCl | NaCl + NaAsc | NaCl | NaCl + NaAsc | (0.25%) | (0.6%) | (0.6%) |
| pH | 6.5 | 5.82 | 5.42 | 5.82 | 5.78 | 7.13 | 8.31 | 9.03 |
| 1 week | 5 | 3 | 4-5 | 2 | 3 | 3 | 2-3 | 1-2 |
| Colour | 5 | 3 | 4 | 2 | 2 | 3 | 2-3 | 1 |
| 4 weeks | 5 | 5 | 4-5 | 4 | 4 | 3 | 1-2 | 1 |
| Colour | 5 | 3 | 3-4 | 2 | 2-3 | 2-3 | 2 | 2 |

| | 4 | 5 | 6 | 7 |
|---|---|---|---|---|
| | Vacuum | Normal | Normal | Normal |
| | NaCl + NaAsc + Na₂CO₃ | NaCl + NaAsc + Na₂CO₃ | NaCl + NaAsc + Na₂CO₃ | NaCl + NaAsc + Na₂CO₃ |
| Oregano | (0.6%) | (0.6%) | (0.6%) | (0.6%) |
| pH | 8.98 | 7.79 | 7.68 | 7.77 |
| 1 week | 1 | 1 | 1 | 1 |
| Colour | 1 | 1-2 | 1-2 | 1-2 |
| 4 weeks | 1-2 | 1 | 1-2 | 1 |
| Colour | 1-2 | 1-2 | 1-2 | 1-2 |

TABLE IV

| | V1 | V2 | V3 | V4 | V5 | 1 | 2 | 3 |
|---|---|---|---|---|---|---|---|---|
| | Normal | | | | | Normal | Normal | Vacuum |
| | nothing | Normal | Normal | Vacuum | Vacuum | NaCl + NaAsc + Na₂CO₃ | NaCl + NaAsc + Na₂CO₃ | NaCl + Na₂CO₃ |
| Rosemary | added | NaCl | NaCl + NaAsc | NaCl | NaCl + NaAsc | (0.25%) | (0.6%) | (0.6%) |
| pH | 5.8 | 5.1 | 5.46 | 5.34 | 5.38 | 7.3 | 8.04 | 8.31 |
| 1 week | 5 | 5 | 3 | 4 | 4-5 | 3 | 2-3 | 1-2 |
| Colour | 5 | 4 | 4 | 1-2 | 1-2 | 3-4 | 2 | 1 |
| 4 weeks | 5 | 5 | 4-5 | 4 | 4-5 | 3-4 | 3 | 1-2 |
| Colour | 5 | 3-4 | 4-5 | 2 | 2 | 3 | 2-3 | 1-2 |

| | 4 | 5 | 6 | 7 |
|---|---|---|---|---|
| | Normal | Normal | Normal | |
| | Vacuum | NaCl + NaAsc + Na₂CO₃ | NaCl + NaAsc + Na₂CO₃ | NaCl + NaAsc + Na₂CO₃ |
| | NaCl + NaAsc + Na₂CO₃ | (0.6%) + CaCO₃ | (0.6%) + MgCl₂.6H₂O | (0.6%) + CaCO₃ |
| Rosemary | (0.6%) | (0.5%) | (0.5%) | (0.6%) + MgCl₂.6H₂O |
| pH | 8.20 | 7.67 | 7.58 | 7.66 |
| 1 week | 1 | 1 | 1 | 1 |
| Colour | 1 | 1-2 | 1-2 | 1-2 |
| 4 weeks | 1 | 2 | 2 | 2 |
| Colour | 1 | 1-2 | 2 | 1-2 |

Equally good results were obtained with the exclusion of oxygen under edible oil instead of in a vacuum pack. The long-term results available for some herbs over several months (up to 18 months) show that the scores which resulted after four weeks did not deteriorate significantly even over a long period.

All in all, it can clearly be seen from the tables that, in the cases of Examples 1 to 7, which fall under the invention, noticeably better scores, both in colour and in aroma, were achieved than in the comparative examples.

The features of the invention disclosed in the above description and in the claims can be essential to implementing the invention in its various embodiments both individually and in any combination.

1. A preserved preparation of at least one pot-herb, comprising:
at least one composition adjusting a water activity of the preparation to 0.90 or less;
at least one substance raising a pH of the preparation by at least 1.0 point compared to the pH of the at least one pot-herb after addition of the composition adjusting the water activity; and,
at least one anti-oxidant or wherein the preparation is packed to be protected against oxygen, or wherein the preparation is both packed to be protected against oxygen and contains at least one anti-oxidant.

2. The preparation of claim 1, wherein the pH is raised between 1.5 and 2.5 points.

3. The preparation of claim 2, wherein the pH is raised by about 2 points.

4. The preparation of claim 1, comprising a proportion of table salt of at least about 10% by weight, based on mass of the preparation.

5. The preparation of claim 4, wherein the proportion of table salt is 20% by weight or more.

6. The preparation of claim 1, wherein the at least one substance to raise the pH is an alkali metal salt of an inorganic acid, an alkali metal salt of an organic acid, an earth alkali metal salt of an inorganic acid, or an earth alkali metal salt of an organic acid.

7. The preparation of claim 6, wherein the the alkali metal salt or earth alkali metal salt is sodium carbonate, sodium bicarbonate, magnesium carbonate or calcium carbonate.

8. The preparation of claim 1, of further comprising at least one earth alkali metal salt.

9. The preparation of claim 8, wherein the at least one earth alkali metal salt is a calcium salt a magnesium salt or a combination thereof.

10. A method of producing a preserved preparation of at least one pot-herb, comprising at least one pot-herb prepared with a moisture content of at least 30% by weight; and wherein the at least one pot-herb is mixed, after or during comminution, with a preservation mixture comprising:
at least one water activity adjusting composition which adjusts a water activity in an amount sufficient to adjust the water activity in the preparation to 0.90 or less,
at least one substance to raise a pH in an amount sufficient to raise the pH by at least 1.0 point compared to the pH of the at least one pot-herb after the addition of the water activity adjusting composition, and
wherein the method further comprises adding at least one anti-oxidant or packing the preparation to be protected against oxygen or both packing the preparation to be protected against oxygen and adding at least one anti-oxidant.

11. The method of claim 10, wherein table salt is added to the preservation mixture in an amount of at least about 10% by weight based on mass of the preparation.

12. The method of claim 11, further comprising at least one substance wherein the at least one substance is an alkali metal salt of an inorganic acid, an alkali metal salt of an organic acid, an earth alkali metal salt of an inorganic acid or an earth alkali metal salt of an organic acid.

13. The method of claim 12, wherein the alkali metal salt and earth alkali metal salt are sodium carbonate, sodium bicarbonate, magnesium carbonate, calcium carbonate or a combination thereof.

14. The method of claim 12, further comprising adding at least one earth alkali metal salt is to the preservation mixture or the mixture of the at least one pot-herb and the preservation mixture.

15. The method of claim 14, wherein the at least one earth alkali metal salt is a calcium salt or a magnesium salt or a combination thereof.

16. The method of claim 10 wherein the proportion of the preservation mixture to the total preparation is between about 25 and 35% by weight.

17. The preparation of claim 2, further comprising a proportion of table salt of at least about 10% by weight, based on mass of the preparation.

18. The preparation of claim 4, wherein the at least one substance to raise the pH is an alkali metal salt of an inorganic acid, an alkali metal salt of an organic acid, an earth alkali metal salt of an inorganic acid, or an earth alkali metal salt of an organic acid.

19. The preparation of claim 6, wherein the at least one substance to raise the pH is an alkali metal salt of an inorganic acid, an alkali metal salt of an organic acid, an earth alkali metal salt of an inorganic acid, or an earth alkali metal salt of an organic acid.

20. The method of claim 12 wherein the proportion of the preservation mixture is between about 25% and 35% by weight based on the mass of the preparation.
